(19) United States
(12) Patent Application Publication
(10) Pub. No.: US 2011/0102282 A1
(43) Pub. Date: May 5, 2011

(54) RECONFIGURABLE MULTI-BAND ANTENNA SYSTEM AND ELECTRONIC APPARATUS HAVING THE SAME

(75) Inventors: Chang-Chih Liu, Taichung County (TW); Chang-Sheng Chen, Taipei City (TW); Kuo-Chiang Chin, Taipei County (TW); Li-Chi Chang, Taichung City (TW); Wei-Ting Chen, Tainan County (TW); Cheng-Hua Tsai, Taipei County (TW)

(73) Assignee: INDUSTRIAL TECHNOLOGY RESEARCH INSTITUTE, Hsinchu (TW)

(21) Appl. No.: 12/773,845

(22) Filed: May 5, 2010

(30) Foreign Application Priority Data
Nov. 2, 2009 (TW) 98137163

(51) Int. Cl. H01Q 9/00

(52) U.S. Cl. 343/745

(57) ABSTRACT

A reconfigurable multi-band antenna system has a signal transmission metal, a ground metal, at least two resonators, and at least two switches. The signal transmission metal and the ground metal respectively act as a signal feed-in end and a ground end and of the reconfigurable multi-band antenna system. The at least two resonators are disposed on at least one side of the transmission metal line. Each switch is coupled to the at least two resonators or one of them. Each switch has a control end, and independently and respectively receives one of the at least two control signals, wherein the at least two control signals respectively and independently the short and open of the switches. The at least two resonators form a resonator configuration of a semi-close resonating configuration or a close resonating configuration, and generates a signal within a frequency according to the resonator configuration.

### CROSS-REFERENCE TO RELATED APPLICATION

This application claims the priority benefit of Taiwan application serial no. 98137163, filed on Nov. 2, 2009. The entirety of the above-mentioned patent application is hereby incorporated by reference herein and made a part of specification.

### TECHNICAL FIELD

The present disclosure is related to an antenna system, and more particularly, to a reconfigurable multi-band antenna system and an electronic apparatus having the same.

### BACKGROUND

The wireless communication develops fast, and many kinds of the communication standards are specified, such as, the mobile phone of the first generation adopts Advanced Mobile Phone System (AMPS) standard, the mobile phone of the second generation adopts Global System for Mobile (GSM) standard, the mobile phone of the third generation adopts Wideband Code Division Multiple Access (WCDMA) standard, the mobile phone of the 3.5 generation adopts High Speed Downlink Packet Access (HSDPA) standard, and the mobile phone of the fourth generation adopts Worldwide Interoperability for Microwave Access (WiMAX) standard and Long Term Evolution (LTE) standard. In addition, other kinds of standards for transmitting the data and video are further specified and improved, such as Wireless Local Area Network (WLAN), Digital Video Broadcasting-Terrestrial (DVB-T), and Digital Video Broadcasting-Handheld (DVB-H). However, these communication standards adopt different frequencies and occupy different frequency bands, and the mobile phone needs an antenna for receiving signals of different frequency bands to support different communication standards.

Recently, the mobile phone is not only the tool for receiving the audio information but also the interface of data transmission, video, and even entertainment. The mobile phone further makes much of integrating the functions of Global Positioning System (GPS), HSDPA, Frequency Modulation (FM) radio reception, WLAN, DVB-T, and so on. However, the essential antenna structures for different communication standards using different frequencies are different from each other, and therefore an antenna being operated in the frequency bands to meet the requirements of different systems is needed under the condition without increasing the circuit area.

### SUMMARY

An exemplary example of the present disclosure provides a reconfigurable multi-band antenna system comprising a signal transmission metal, a ground metal, at least two resonators, and at least two switches. The signal transmission metal and the ground metal respectively act as a signal feed-in end and a ground end and of the reconfigurable multi-band antenna system. The at least two resonators are disposed on at least one side of the transmission metal line. Each switch is coupled to the at least two resonators or one of them. Each switch has a control end, and independently and respectively receives one of the at least two control signals, wherein the at least two control signals respectively and independently control the switches to be short or open. The at least two resonators form a resonator configuration of a semi-close resonating configuration or a close resonating configuration, and generates a signal within a frequency according to the resonator configuration.

An exemplary example of the present disclosure provides an electronic apparatus comprising a transceiving chip and a reconfigurable multi-band antenna system, wherein the transceiving chip electrically connects to the reconfigurable multi-band antenna system. The reconfigurable multi-band antenna system comprises a signal transmission metal, a ground metal, at least two resonators, and at least two switches. The signal transmission metal and the ground metal respectively act as a signal feed-in end and a ground end and of the reconfigurable multi-band antenna system. The at least two resonators are disposed on at least one side of the transmission metal line. Each switch is coupled to the at least two resonators or one of them. Each switch has a control end, and independently and respectively receives one of the at least two control signals, wherein the at least two control signals respectively and independently control the switches to be short or open. The at least two resonators form a resonator configuration of a semi-close resonating configuration or a close resonating configuration, and generates a signal within a frequency according to the resonator configuration.

Accordingly, the reconfigurable multi-band antenna system mentioned above can control the switches to be short (i.e. turned on) or open (i.e. turned off) via the controls signals, such that the resonator configurations finally formed are different, and therefore the reconfigurable multi-band antenna system is able to operate in different frequency bands.

It is to be understood that both the foregoing general description and the following detailed description are exemplary, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a plan diagram showing a reconfigurable multi-band antenna system 100 provided by an exemplary example.

FIG. 2 is a cross-sectional diagram showing the structure of the substrate of the reconfigurable multi-band antenna system 100 provided by an exemplary example.

FIGS. 3A-3I are schematic diagrams respectively showing the different resonator configurations formed by the resonators of the reconfigurable multi-band antenna system 100.

FIGS. 4A-4I are curve diagrams respectively showing the return losses corresponding to the resonator configurations of FIGS. 3A-3I.

FIG. 5 is a schematic diagram showing the operating frequency bands BW_1-BW_9 of the reconfigurable multi-band antenna system 100 according to the control signals and the frequency bands adopted by the communication standards.

FIG. 6 is a table showing the maximum/middle/minimum frequencies and the maximum gains of the resonator configurations of FIG. 4A-4I.

FIG. 7A is a plan diagram of the reconfigurable multi-band antenna system 200 provided by an exemplary example.

FIG. 7B is a plan diagram of the reconfigurable multi-band antenna system 220 provided by an exemplary example.

FIG. 8A is a plan diagram of the reconfigurable multi-band antenna system 300 provided by an exemplary example.

FIG. 8B is a plan diagram of the reconfigurable multi-band antenna system 320 provided by an exemplary example.

FIG. 9 is a plan diagram of the reconfigurable multi-band antenna system 400 provided by an exemplary example.

FIG. 10A is a plan diagram of the reconfigurable multi-band antenna system 500 provided by an exemplary example.

FIG. 10B is a plan diagram of the reconfigurable multi-band antenna system 530 provided by an exemplary example.

FIG. 10C is a plan diagram of the reconfigurable multi-band antenna system 560 provided by an exemplary example.

FIG. 11A is a plan diagram of the reconfigurable multi-band antenna system 600 provided by an exemplary example.

FIG. 11B is a plan diagram of the reconfigurable multi-band antenna system 620 provided by an exemplary example.

FIG. 11C is a plan diagram of the reconfigurable multi-band antenna system 630 provided by an exemplary example.

FIG. 11D is a plan diagram of the reconfigurable multi-band antenna system 640 provided by an exemplary example.

FIG. 11E is a plan diagram of the reconfigurable multi-band antenna system 650 provided by an exemplary example.

FIG. 11F is a plan diagram of the reconfigurable multi-band antenna system 660 provided by an exemplary example.

FIG. 11G is a plan diagram of the reconfigurable multi-band antenna system 670 provided by an exemplary example.

FIG. 12A is a plan diagram of the reconfigurable multi-band antenna system 800 provided by an exemplary example.

FIG. 12B is a plan diagram of the reconfigurable multi-band antenna system 820 provided by an exemplary example.

FIG. 12C is a plan diagram of the reconfigurable multi-band antenna system 840 provided by an exemplary example.

FIG. 13 is a plan diagram of the reconfigurable multi-band antenna system 900 provided by an exemplary example.

FIG. 14 is a perspective diagram of the reconfigurable multi-band antenna system 990 provided by an exemplary example.

### DESCRIPTION OF THE EMBODIMENTS

Reference will now be made in detail to the present embodiment of the disclosure, examples of which are illustrated in the accompanying drawings. Wherever possible, the same reference numbers are used in the drawings and the description to refer to the same or like parts.

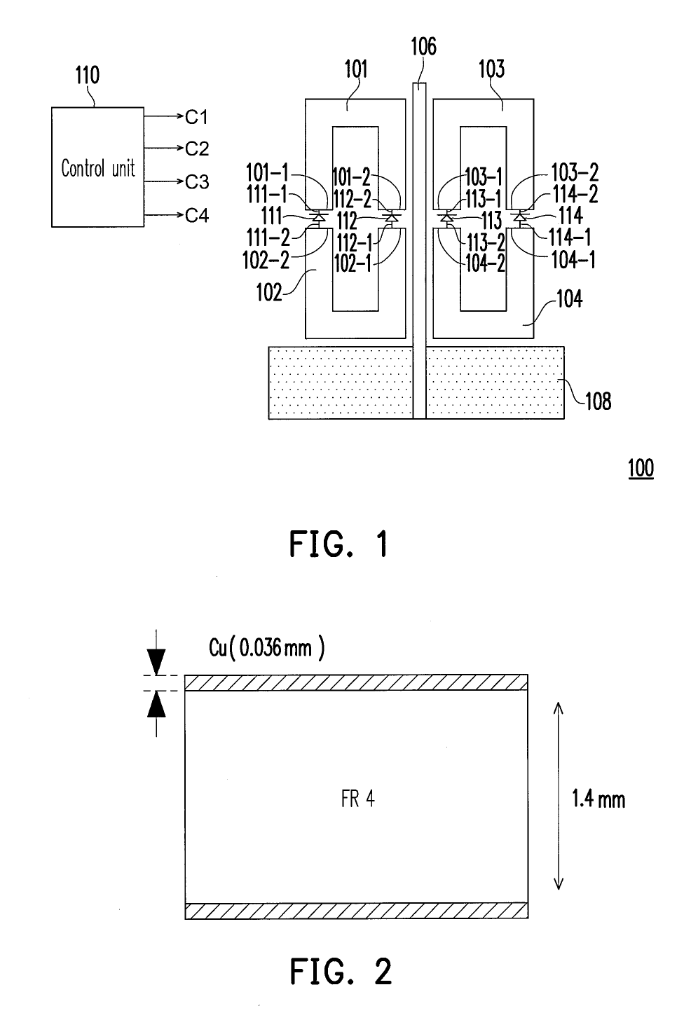

Referring to FIG. 1, FIG. 1 is a plan diagram showing a reconfigurable multi-band antenna system 100 provided by an exemplary example. The reconfigurable multi-band antenna system 100 is a system with a single antenna which is able to be operated in different frequency bands. The reconfigurable multi-band antenna system 100 comprises four semi-close resonators 101-104, signal transmission metal 106, ground metal 108, four switches 111-114 and a control unit 110. The signal transmission metal 106 acts as a signal feed-in end of the reconfigurable multi-band antenna system 100, and the ground metal 108 acts as a ground end of the reconfigurable multi-band antenna system 100. The semi-close resonators 101-104 are uniformly and symmetrically arranged on the two sides of the transmission metal 106. It is noted that FIG. 1 just shows the plan view of the reconfigurable multi-band antenna system 100, though in the plan view, the signal transmission metal 106 and the ground metal 108 are overlapped, the signal transmission metal 106 is not connected to the ground metal 108 in fact.

One end 111-1 of the switch 111 is connected to one end 101-1 of the semi-close resonator 101. One end 112-1 of the switch 112 is connected to one end 102-1 of the semi-close resonator 102. The other one end 111-2 of the switch 111 is connected to one end 102-2 of the semi-close resonator 102. The other one end 112-2 of the switch 112 is connected to one end 101-2 of the semi-close resonator 101. One end 113-1 of the switch 113 is connected to one end 103-1 of the semi-close resonator 103. One end 114-1 of the switch 114 is connected to one end 104-1 of the semi-close resonator 104. The other one end 113-2 of the switch 113 is connected to one end 104-2 of the semi-close resonator 104. The other one end 114-2 of the switch 114 is connected to one end 103-2 of the semi-close resonator 103. The control unit 110 generates the control signals C1-C4 applied on the control ends of the switches 111-114, so as to control the switches 111-114 to be short (i.e. turned on) or open (i.e. turned off). When all of the switches 111-114 are short, the semi-close resonators 101-104 form two close resonators. In other words, the resonator configuration is the close resonating configuration substantially having the two close resonators.

It is noted that, the transmission metal 106 and semi-close resonators 101-104 mentioned above can be implemented by the microstrip lines, but the implementation of reconfigurable multi-band antenna system 100 is not limited to be implemented by the microstrip lines. The switches 111-114 are radio frequency (RF) switches, and can be implemented by the P-doped Instinct N-doped (PIN) diode switches, but the implementation of the switches 111-114 is not limited to be implemented by the PIN diode switches. The switches 111-114 can be further implemented by the Radio Frequency MicroElectroMechanical System (RF MEMS) switches or the Metal-Oxide-Semiconductors (MOS) switches. In addition, referring to FIG. 2, FIG. 2 is a cross-sectional diagram showing the structure of the substrate of the reconfigurable multi-band antenna system 100 provided by an exemplary example. All elements of the reconfigurable multi-band antenna system 100 shown in FIG. 1 are on the substrate, and the substrate can be a Flame Retardant 4 (FR4) dual layer substrate with a depth of 1.4 millimeter, and depth the copper (Cu) layer disposed thereon is 0.036 millimeter. In other words, the reconfigurable multi-band antenna system 100 further has a FR4 dual layer substrate. Furthermore, the implementation of the substrate of the reconfigurable multi-band antenna system 100 provided by FIG. 2 is just an exemplary example which is not used to limit the reconfigurable multi-band antenna system in the present disclosure.

The signals of the reconfigurable multi-band antenna system 100 feed in the monopole antenna via the microstrip line, and then signals in the four semi-close resonators 101-104 are excited, such that the signal within the corresponding frequency is excited. To put it concretely, the reconfigurable multi-band antenna system 100 controls the switches 111-114 to be short or open via the control signals C1-C4, so as to control the connections of the semi-close resonators 101-104. Thus the reconfigurable multi-band antenna system 100 can have many different resonator configurations and excite signals within different frequencies. The control unit 110 generates the controls signal C1-C4 according to the frequency of the signal to be transceived by the user, and the resonator configuration of the reconfigurable multi-band antenna system 100 is thus controlled via the control signals C1-C4. In the other exemplary example, the control unit 110 may generate the control signals C1-C4 according to the antenna gain, and the resonator configuration appropriate to the current communication environment is thus selected to maintain the acceptable communication quality.

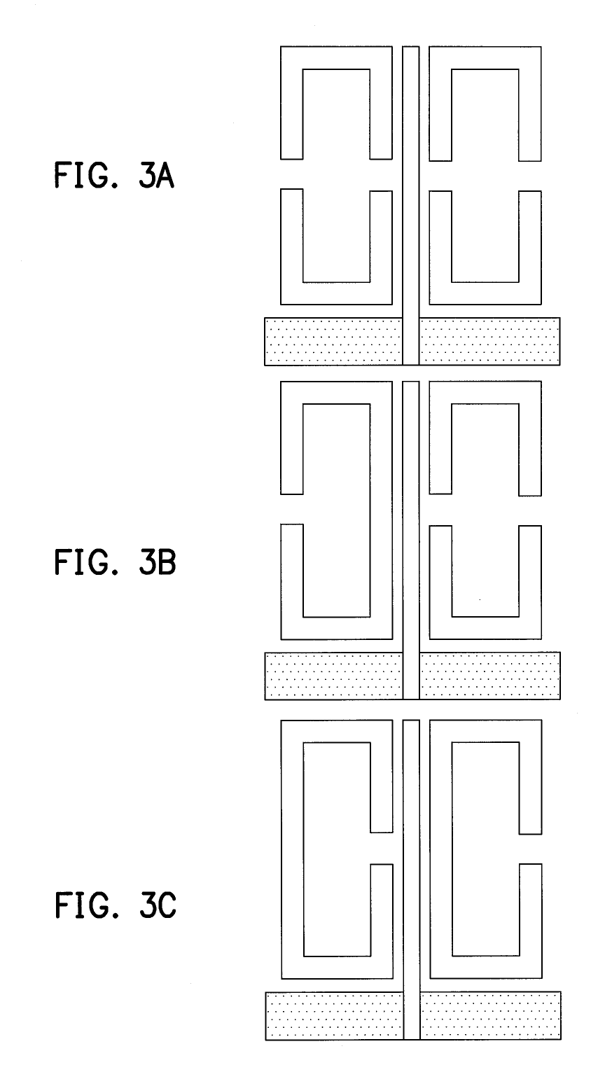

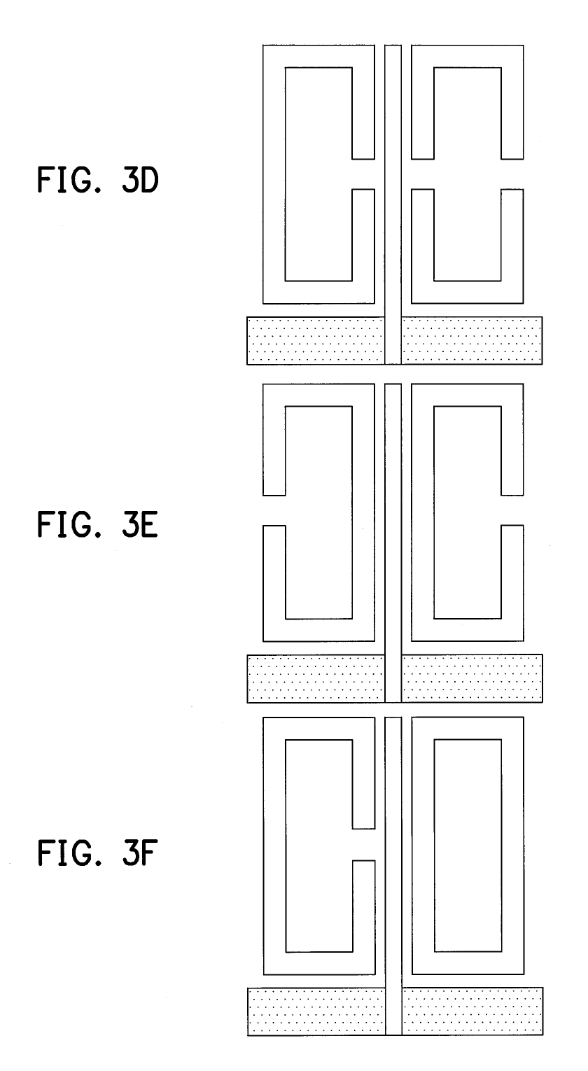

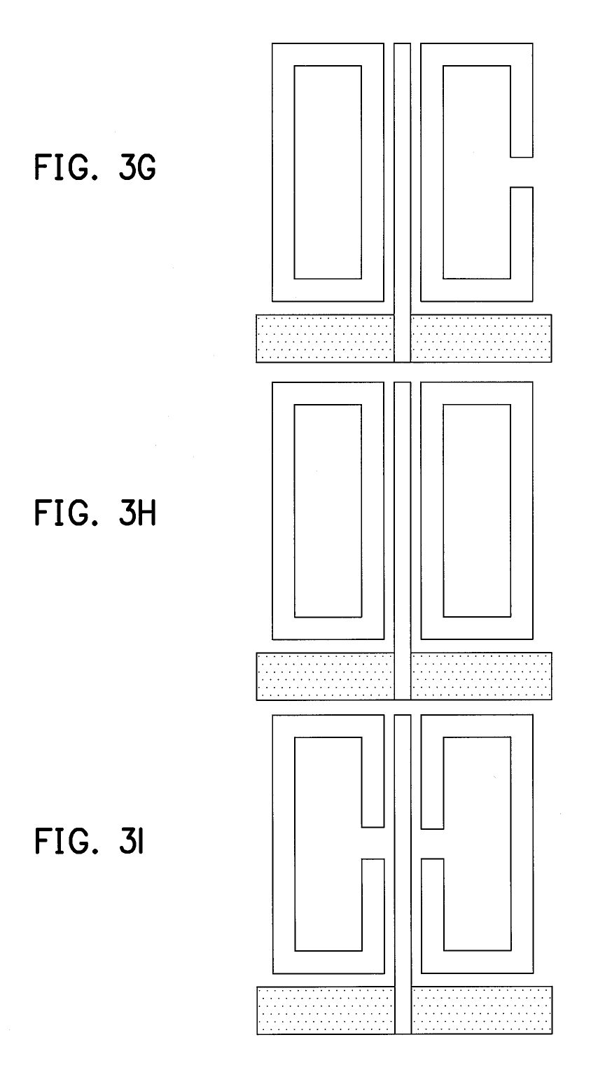

It is noted that, the frequency of the signal excited by the resonators which are formed by the semi-close resonators 101-104 and the switches 111-114 is a two dimensional function of the variables of the lengths and the positions (the relative positions between the formed resonators and the signal transmission metal 106) of the formed resonators. Referring to FIGS. 3A-3I, FIGS. 3A-3I are schematic diagrams respectively showing the different resonator configurations formed by the resonators of the reconfigurable multi-band antenna system 100. Herein the mark “F” represents the open state of the switch, the mark “N” represents the short state of the switch, and the resonator configurations of the reconfigurable multi-band antenna system 100 can be represented by the states of the switches 111-114.

In FIG. 3A, the switches 111-114 are open, and the four semi-close resonators 101-104 are not connected to each other, thus forming a resonator configuration of “FFFF” as shown in the FIG. 3A. The configurations of FIGS. 3B-3I are deduced in the similar manner, and the resonator configurations of FIGS. 3B-3I are respectively configurations of “FNFF”, “NFNF”, “NFFF”, “FNNF”, “NFNN”, “NNNF”, “NNNN”, and “NFFN”. It is noted that, the lengths of the formed resonators of “NFNF” resonator configuration in FIG. 3C and “FNNF” resonator configuration in FIG. 3E are the same, but because the frequency of the signal excited by the resonators which are formed by the semi-close resonators 101-104 and the switches 111-114 is a two dimensional function of the variables of the lengths and the positions of the formed resonators, the resonating configurations of resonator configurations in FIGS. 3C and 3E are thus different from each other. The reconfigurable multi-band antenna system 100 with the structure of the single antenna can have different resonator configurations without increasing circuit area. Therefore the reconfigurable multi-band antenna system 100 can satisfy the trend which the mobile phone must be smaller and have more functions.

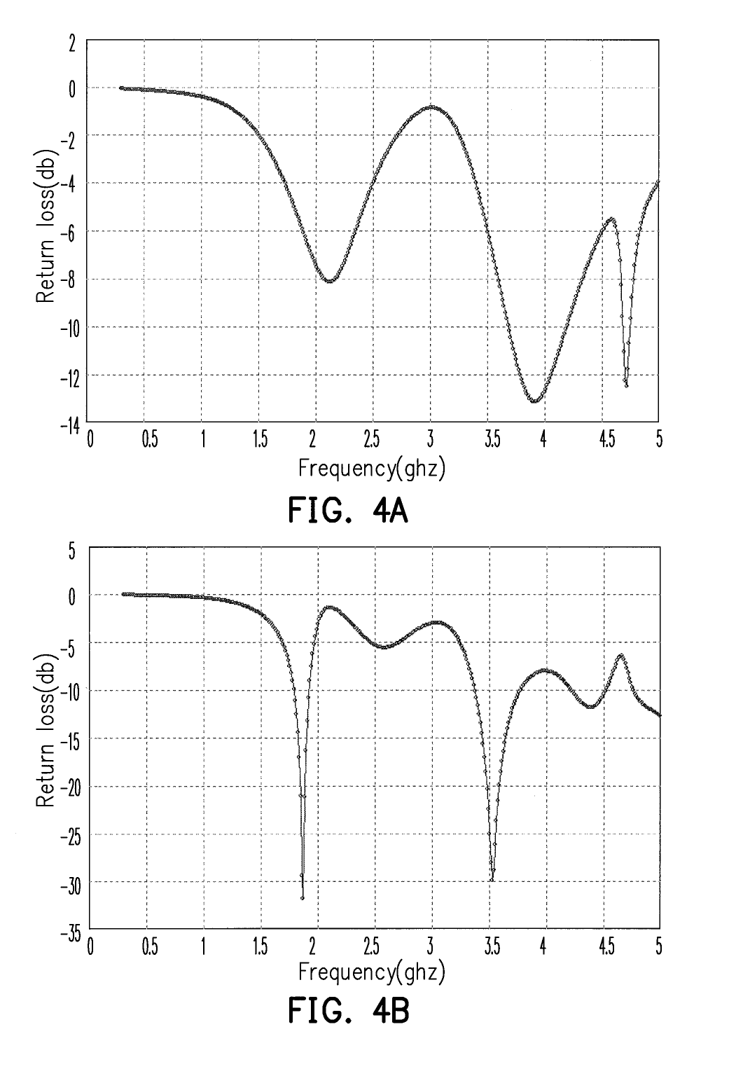

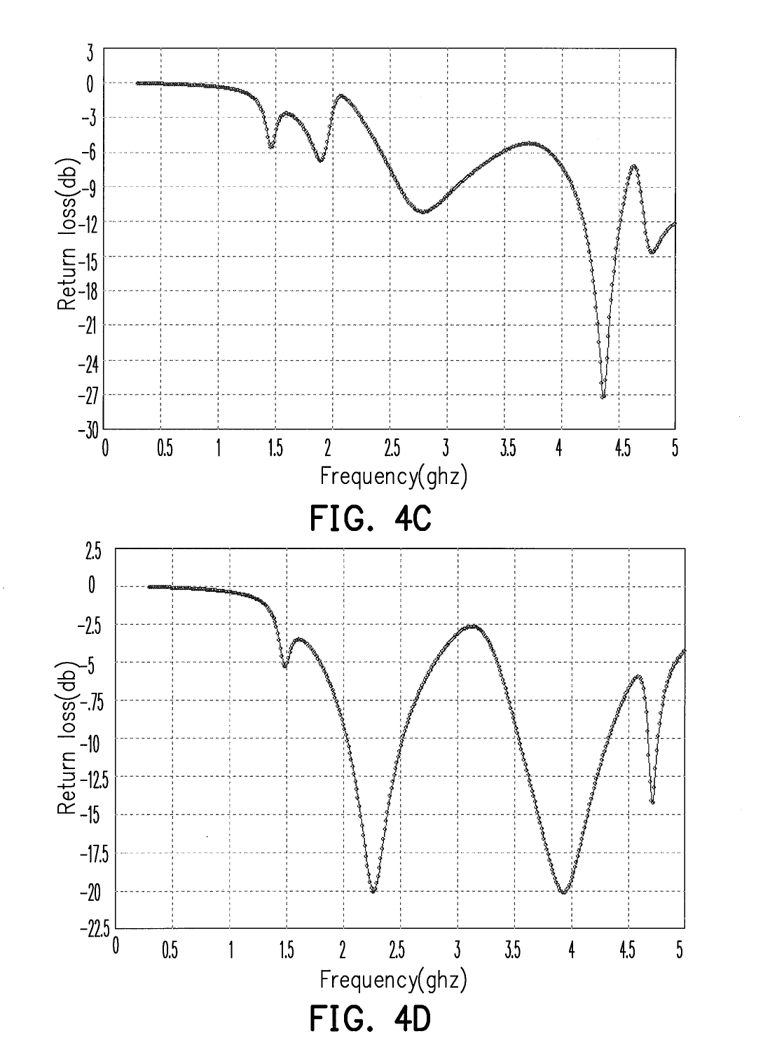

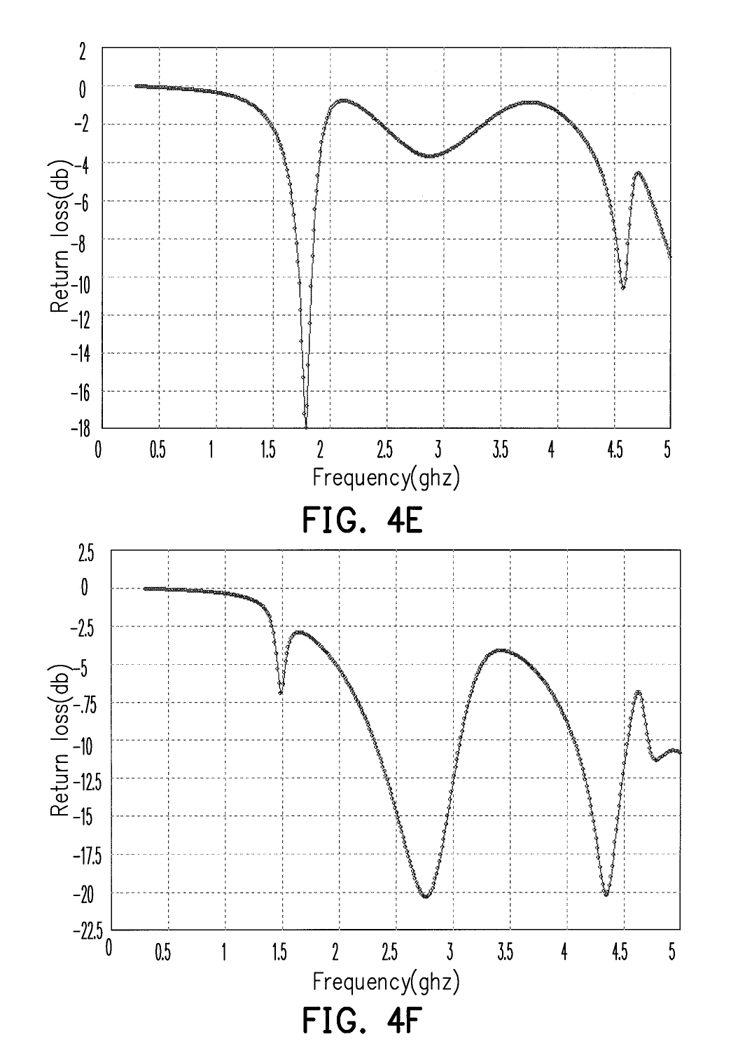

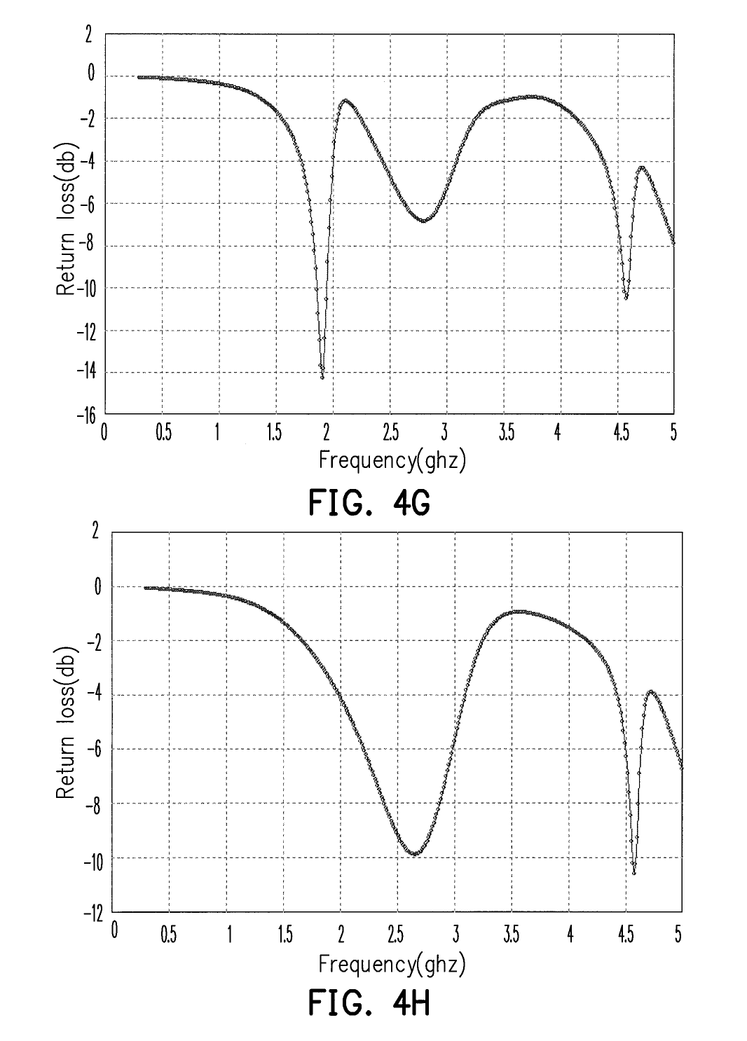

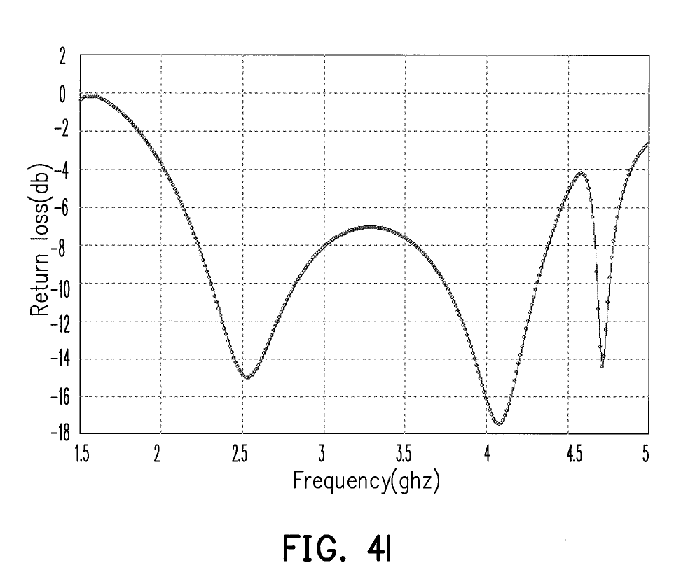

Next, referring to FIGS. 4A-4I, FIGS. 4A-4I are curve diagrams respectively showing the return losses corresponding to the resonator configurations of FIGS. 3A-3I. From FIGS. 4A-4I, it is obvious that when the reconfigurable multi-band antenna system 100 operates in the different resonator configurations, there are different resonating configurations existing.

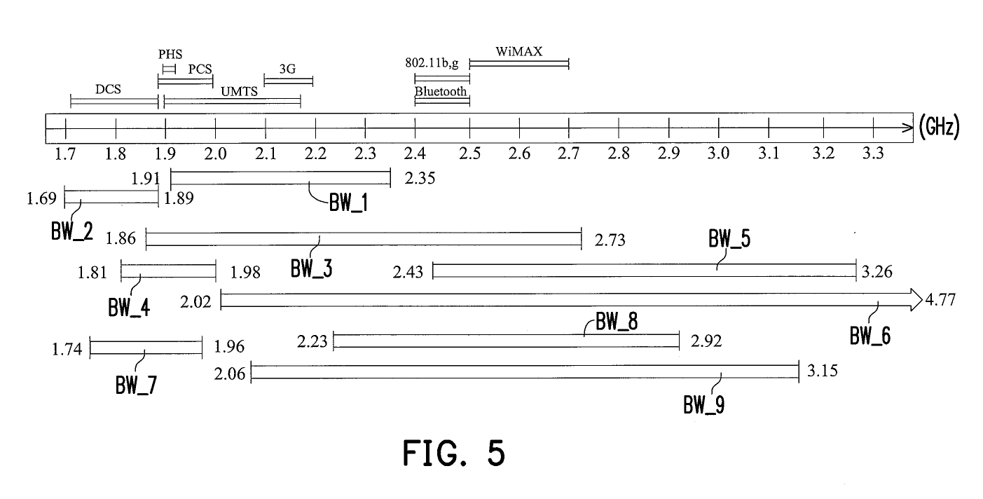

Referring to FIG. 5, FIG. 5 is a schematic diagram showing the operating frequency bands BW_1-BW_9 of the reconfigurable multi-band antenna system 100 according to the control signals and the frequency bands adopted by the communication standards. The frequency bands shown in FIG. 5 are the results of the reconfigurable multi-band antenna system 100 which is operated when the voltage standing wave ratio (VSWR) is 3:1. From FIGS. 4A-4I, the 9 resonator configurations of the reconfigurable multi-band antenna system 100 can form 9 frequency bands BW_1-BW-9 as shown in FIG. 5. The operating frequency bands of the reconfigurable multi-band antenna system 100 cover the frequency bands adopted by the most current communication standards, the current communication standards comprise the standards of Digital Cellular System (DCS), Personal Handy-phone System (PHS), Personal Communications Services (PCS), Universal Mobile Telecommunications System (UMTS), 3G, Bluetooth, IEEE 802.11b, IEEE 802.11g, and WiMAX.

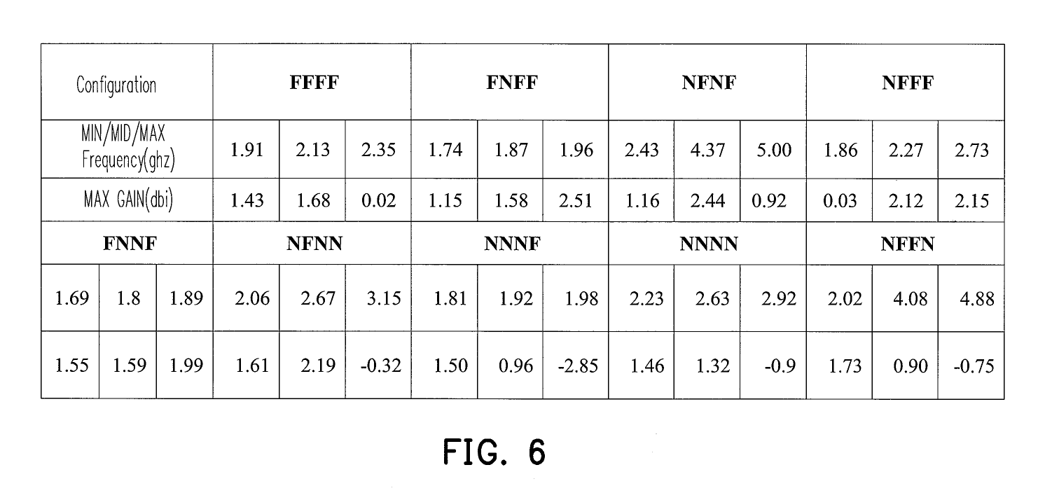

Referring to FIG. 6, FIG. 6 is a table showing the maximum/middle/minimum frequencies and the maximum gains of the resonator configurations of FIG. 4A˜4I. As shown in the table of FIG. 6, the reconfigurable multi-band antenna system 100 can form the different resonator configurations, so as to be operated in the different frequency bands. That is, the different frequency bands corresponding to the different resonator configurations may both cover the specific frequency band. Thus the control unit can also generate the control signals according to the antenna gain, so as to select a resonator configuration appropriate to the current communication environment for maintaining the acceptable communication quality.

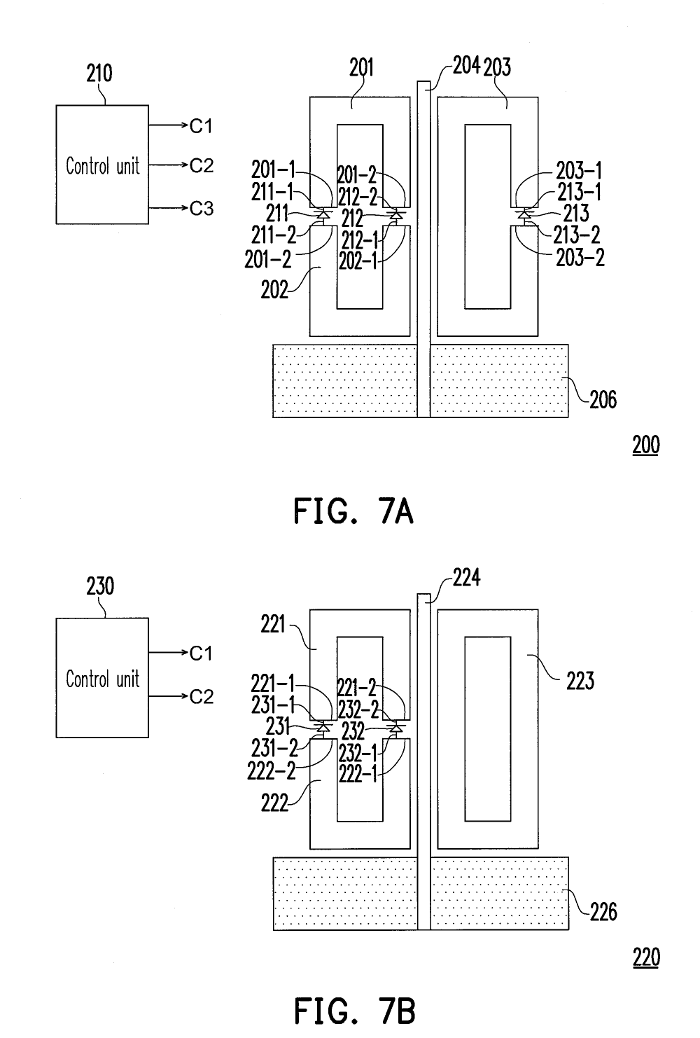

Next, referring to FIG. 7A, FIG. 7A is a plan diagram of the reconfigurable multi-band antenna system 200 provided by an exemplary example. The reconfigurable multi-band antenna system 200 comprises semi-close resonators 201-203, a signal transmission metal 204, a ground metal 206, a control unit 210, and switches 211-213. The signal transmission metal 204 and the ground metal 206 are the same as those of FIG. 1, thus being not described again herein. The difference between FIG. 1 and FIG. 7A is that the reconfigurable multi-band antenna system 200 only comprises three semi-close resonators 201-203 and three switches 211-213, and the control unit only generates three control signals C1-C3 to control the switches 211-213 to be short or open. One end 211-1 of the switch 211 is connected to one end 201-1 of the semi-close resonator 201. One end 212-1 of the switch 212 is connected to one end 202-1 of the semi-close resonator 202. The other one end 211-2 of the switch 211 is connected to one end 202-2 of the semi-close resonator 202. The other one end 212-2 of the switch 212 is connected to one end 201-2 of the semi-close resonator 201. One end 213-1 of the switch 213 is connected to one end 203-1 of the semi-close resonator 203. The other one end 213-2 of the switch 213 is connected to one end 203-2 of the semi-close resonator 203. When the switches 211-213 are short, the semi-close resonators 201-203 and the switches 211-213 form two close resonators.

The control unit 210 controls the resonator configurations of the reconfigurable multi-band antenna system 200 via the control signals C1-C3. For example, when the switches 211-213 are open, and the “FFF” configuration is formed, the formed resonators are the same as those of FIG. 3B. For another example, when the switches 211 and 212 are short, the switch 213 is open, and the “NNF” configuration is formed, the formed resonators are the same as those of FIG. 3G. Accordingly, the reconfigurable multi-band antenna system 200 with the structure of the single antenna can have different resonator configurations.

Next, referring to FIG. 7B, FIG. 7B is a plan diagram of the reconfigurable multi-band antenna system 220 provided by an exemplary example. The reconfigurable multi-band antenna system 220 comprises semi-close resonators 221, 222, a close resonator 223, a signal transmission metal 224, a ground metal 226, a control unit 230, and switches 231-232. The signal transmission metal 224 and the ground metal 226 are the same as those of FIG. 1, thus being not described again herein. The difference between FIG. 1 and FIG. 7B is that the reconfigurable multi-band antenna system 220 only comprises two semi-close resonators 221-222, two switches 231, 232 and uses a close resonator 223 to replace the semi-close resonators 103 and 104, and the control unit only generates two control signals C1-C2 to control the switches 231, 232 to be short or open. One end 231-1 of the switch 231 is connected to one end 221-1 of the semi-close resonator 221. One end 232-1 of the switch 232 is connected to one end 222-1 of the semi-close resonator 222. The other one end 231-2 of the switch 231 is connected to one end 222-2 of the semi-close resonator 222. The other one end 232-2 of the switch 232 is connected to one end 221-2 of the semi-close resonator 221. When the switches 231 and 232 are short, the semi-close resonators 221, 222, the close resonator 233, and the switches 231, 232 form two close resonators.

The control unit 230 controls the resonator configurations of the reconfigurable multi-band antenna system 220 via the controls signals C1-C2. For example, when the switches 231-232 are short, and the “NN” configuration is formed, the formed resonators are the same as those of FIG. 3H. For another example, when the switch 231 is short, the switch 232 is open, and the “NF” configuration is formed, the formed resonators are the same as those of FIG. 3F. Accordingly, the reconfigurable multi-band antenna system 220 with the structure of the single antenna can have different resonator configurations.

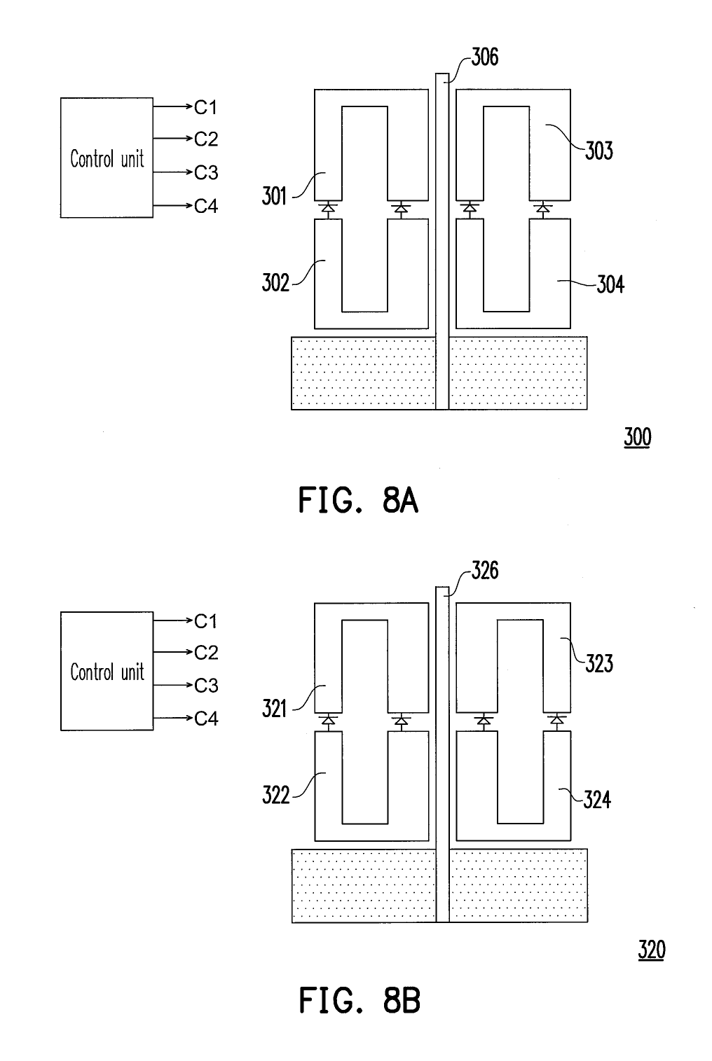

Next, referring to FIG. 8A, FIG. 8A is a plan diagram of the reconfigurable multi-band antenna system 300 provided by an exemplary example. The difference between FIG. 8A and FIG. 1 is that the semi-close resonators 101-104 in FIG. 1 are the resonators with the uniform line widths (i.e. line impedances are the same), and the semi-close resonators 301-304 in FIG. 8A are the resonators with non-uniform line widths (i.e. line impedances are different from each other). In addition, the semi-close resonators 101-104 in FIG. 1A are symmetrically arranged on the two sides of the signal transmission metal 106, however the semi-close resonators 301-304 in FIG. 8A are asymmetrically arranged on the two sides of the signal transmission metal 306. That is, the sides of the larger line widths of the semi-close resonators 303 and 304 are farer from the signal transmission metal 306 as shown in FIG. 8A, and the sides of the larger line widths of the semi-close resonators 301 and 302 are nearer the signal transmission metal 306 as shown in FIG. 8A.

In addition, referring to FIG. 8B, FIG. 8B is a plan diagram of the reconfigurable multi-band antenna system 320 provided by an exemplary example. The difference between FIG. 8A and FIG. 8B is that the semi-close resonators 321-324 in FIG. 8B are symmetrically arranged on the two sides of the signal transmission metal. That is the sides of the semi-close resonators 321-324 having of the larger line widths are nearer the signal transmission metal 326 as shown in FIG. 8B.

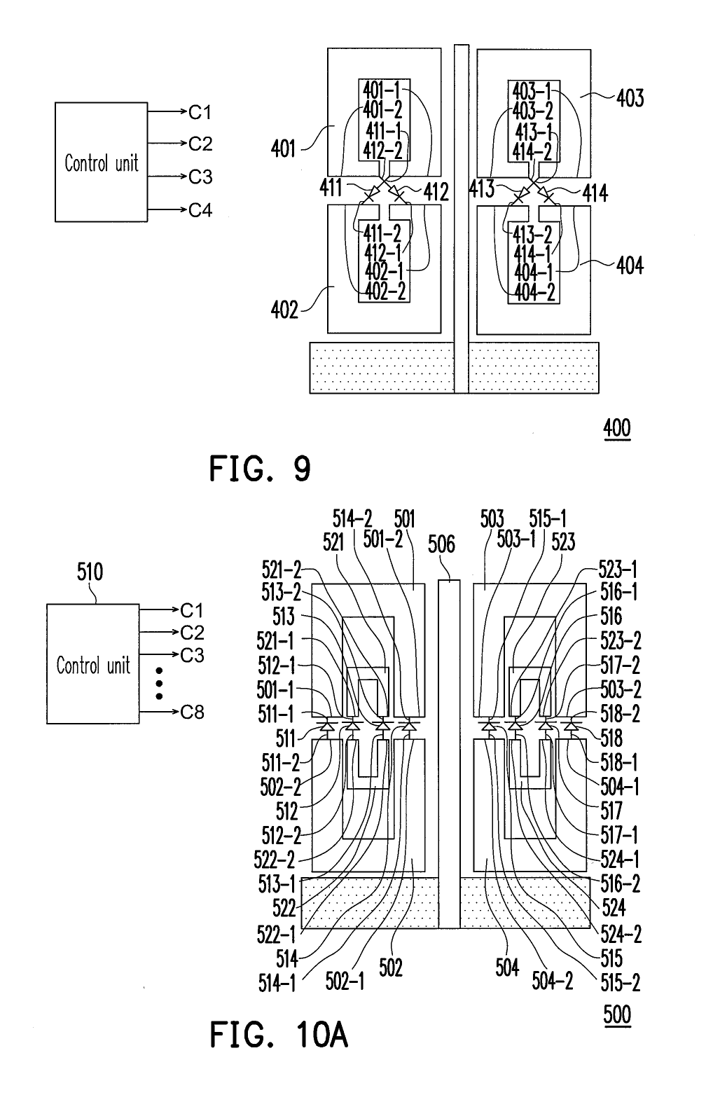

Referring to FIG. 9, FIG. 9 is a plan diagram of the reconfigurable multi-band antenna system 400 provided by an exemplary example. The difference between FIG. 1 and FIG. 9 is that the connections of the semi-close resonators 401-404 and the switches 411-414 in the reconfigurable multi-band antenna system 400 in FIG. 9 are cross. One end 411-1 of the switch 411 is connected to one end 401-1 of the semi-close resonator 401. One end 412-1 of the switch 412 is connected to one end 402-1 of the semi-close resonator 402. The other one end 411-2 of the switch 411 is connected to one end 402-2 of the semi-close resonator 402. The other one end 412-2 of the switch 412 is connected to one end 401-2 of the semi-close resonator 401. One end 413-1 of the switch 413 is connected to one end 403-1 of the semi-close resonator 403. One end 414-1 of the switch 414 is connected to one end 404-1 of the semi-close resonator 404. The other one end 413-2 of the switch 413 is connected to one end 404-2 of the semi-close resonator 404. The other one end 414-2 of the switch 414 is connected to one end 403-2 of the semi-close resonator 403. When the switches 411-414 are short, the semi-close resonators 401-404 and the switches 411-414 form two close resonators of “8” shapes.

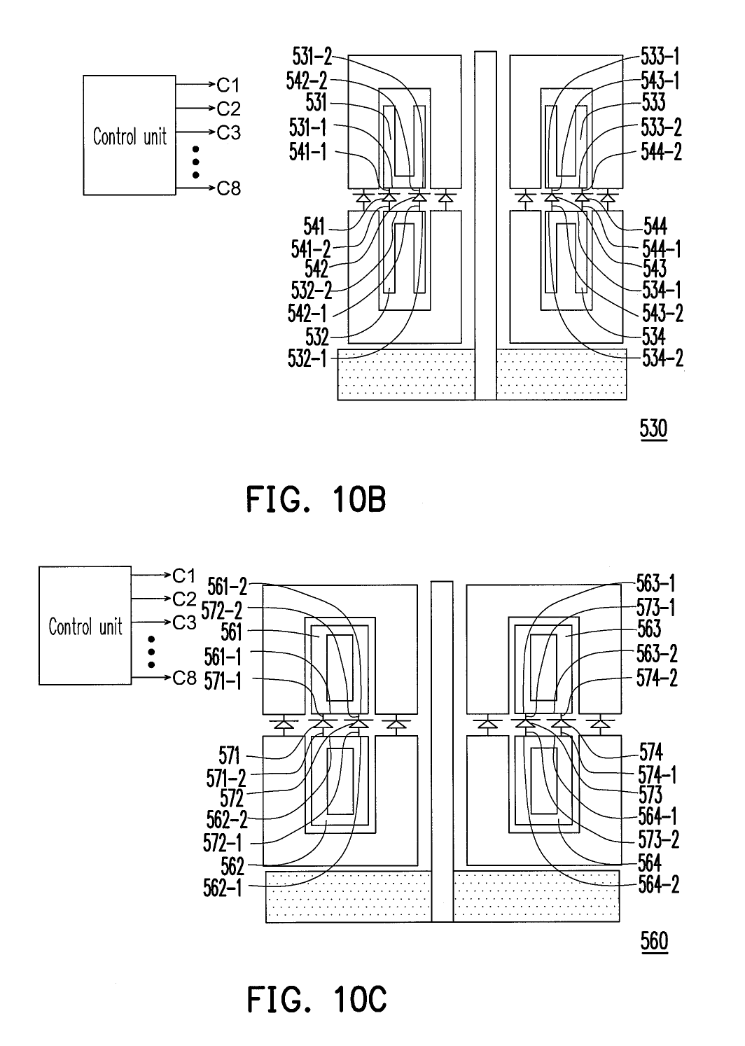

Next, referring to FIG. 10A, FIG. 10A is a plan diagram of the reconfigurable multi-band antenna system 500 provided by an exemplary example. The difference between FIG. 1 and FIG. 10 is that the reconfigurable multi-band antenna system 500 has inner resonators 521-524 and inner switches 512-513 and 516-517, wherein the inner resonators 521-522 and 523-524 are semi-close resonators surrounded by the semi-close resonators 501-502 and 503-504. That is, the inner resonators 521-522 are arranged on the inner sides of the semi-close resonators 501 and 502, and the inner resonators 523-524 are arranged on the inner sides of the semi-close resonators 503 and 504.

One end 511-1 of the switch 511 is connected to one end 501-1 of the semi-close resonator 501. One end 514-1 of the switch 514 is connected to one end 502-1 of the semi-close resonator 502. The other one end 511-2 of the switch 511 is connected to one end 502-2 of the semi-close resonator 502. The other one end 514-2 of the switch 514 is connected to one end 501-2 of the semi-close resonator 501. One end 515-1 of the switch 515 is connected to one end 503-1 of the semi-close resonator 503. One end 518-1 of the switch 518 is connected to one end 504-1 of the semi-close resonator 504. The other one end 515-2 of the switch 515 is connected to one end 504-2 of the semi-close resonator 504. The other one end 518-2 of the switch 518 is connected to one end 503-2 of the semi-close resonator 503.

One end 512-1 of the inner switch 512 is connected to one end 521-1 of the inner resonator 521. One end 513-1 of the inner switch 513 is connected to one end 522-1 of the inner resonator 522. The other one end 512-2 of the inner switch 512 is connected to one end 522-2 of inner resonator 522. The other one end 513-2 of the inner switch 513 is connected to one end 521-2 of inner resonator 521. One end 516-1 of the inner switch 516 is connected to one end 523-1 of the inner resonator 523. One end 517-1 of the inner switch 517 is connected to one end 524-1 of the inner resonator 524. The other one end 516-2 of the inner switch 516 is connected to one end 524-2 of inner resonator 524. The other one end 517-2 of the inner switch 517 is connected to one end 523-2 of inner resonator 523. When the control unit 510 controls the switches 511-518 to be short, each side the signal transmission line has two close resonators, wherein one close resonator of the formed two close resonators is surrounded by the other one.

Next, referring to FIG. 10B and FIG. 10C, FIG. 10B is a plan diagram of the reconfigurable multi-band antenna system 530 provided by an exemplary example, and FIG. 10C is a plan diagram of the reconfigurable multi-band antenna system 560 provided by an exemplary example. The difference between FIG. 10A and FIG. 10B is the arrangement of the inner resonators 531-534 of the reconfigurable multi-band antenna system 530 is different from that of FIG. 10A. One end 541-1 of the inner switch 541 is connected to one end 531-1 of the inner resonator 531. One end 542-1 of the inner switch 542 is connected to one end 532-1 of the inner resonator 532. The other one end 541-2 of the inner switch 541 is connected to one end 532-2 of inner resonator 532. The other one end 542-2 of the inner switch 542 is connected to one end 531-2 of inner resonator 531. One end 543-1 of the inner switch 543 is connected to one end 533-1 of the inner resonator 533. One end 544-1 of the inner switch 544 is connected to one end 534-1 of the inner resonator 534. The other one end 543-2 of the inner switch 543 is connected to one end 534-2 of inner resonator 534. The other one end 544-2 of the inner switch 544 is connected to one end 533-2 of inner resonator 533. When the inner switches 541-544 are controlled to be short, the inner resonators 531-534 do not form two close resonators, but form two semi-close resonators of “H” shapes.

The difference between FIGS. 10C and 10A is that the inner resonators 561-564 are not semi-close resonators, but the close semi-close resonators. One end 571-1 of the inner switch 571 is connected to one end 561-1 of the inner resonator 561. One end 572-1 of the inner switch 572 is connected to one end 562-1 of the inner resonator 562. The other one end 571-2 of the inner switch 571 is connected to one end 562-2 of inner resonator 562. The other one end 572-2 of the inner switch 572 is connected to one end 561-2 of inner resonator 561. One end 573-1 of the inner switch 573 is connected to one end 563-1 of the inner resonator 563. One end 574-1 of the inner switch 574 is connected to one end 564-1 of the inner resonator 564. The other one end 573-2 of the inner switch 573 is connected to one end 564-2 of inner resonator 564. The other one end 574-2 of the inner switch 574 is connected to one end 563-2 of inner resonator 563. When the inner switches 571-574 are short, the inner resonators 561-564 form two close resonators of “8” shapes.

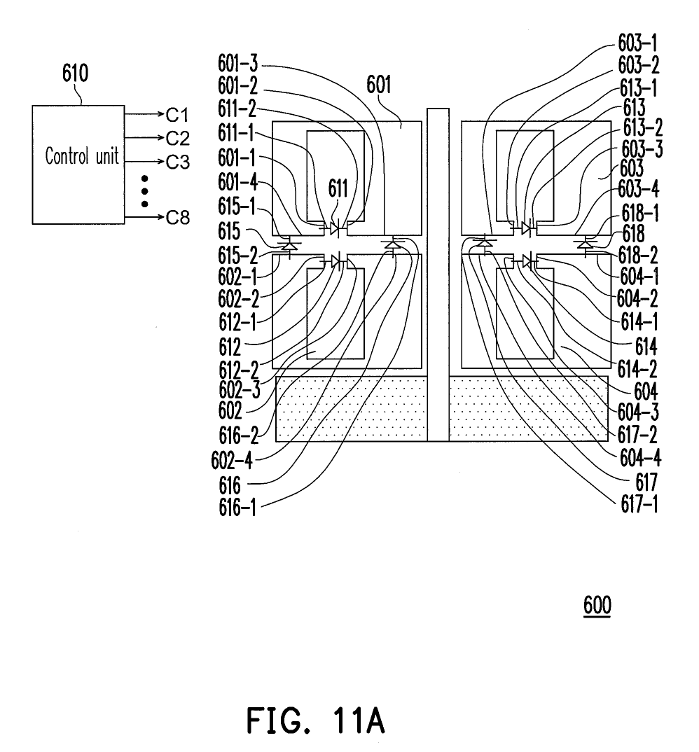

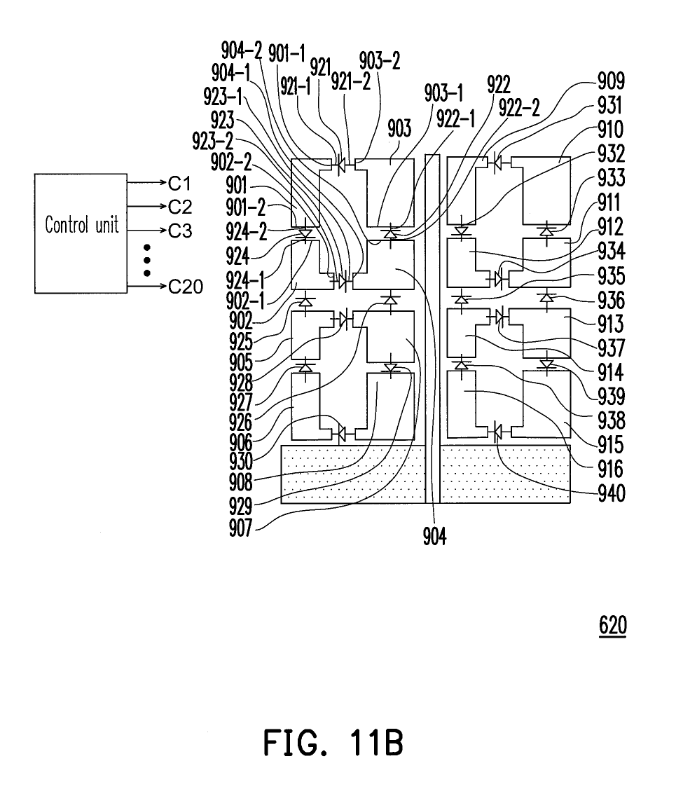

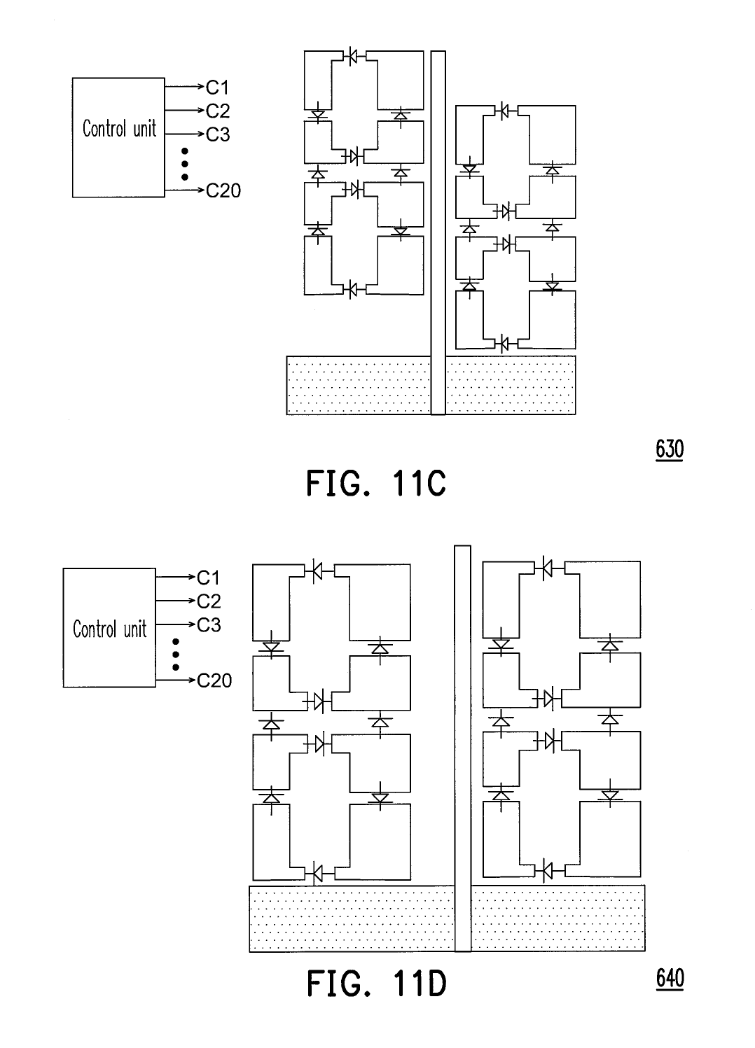

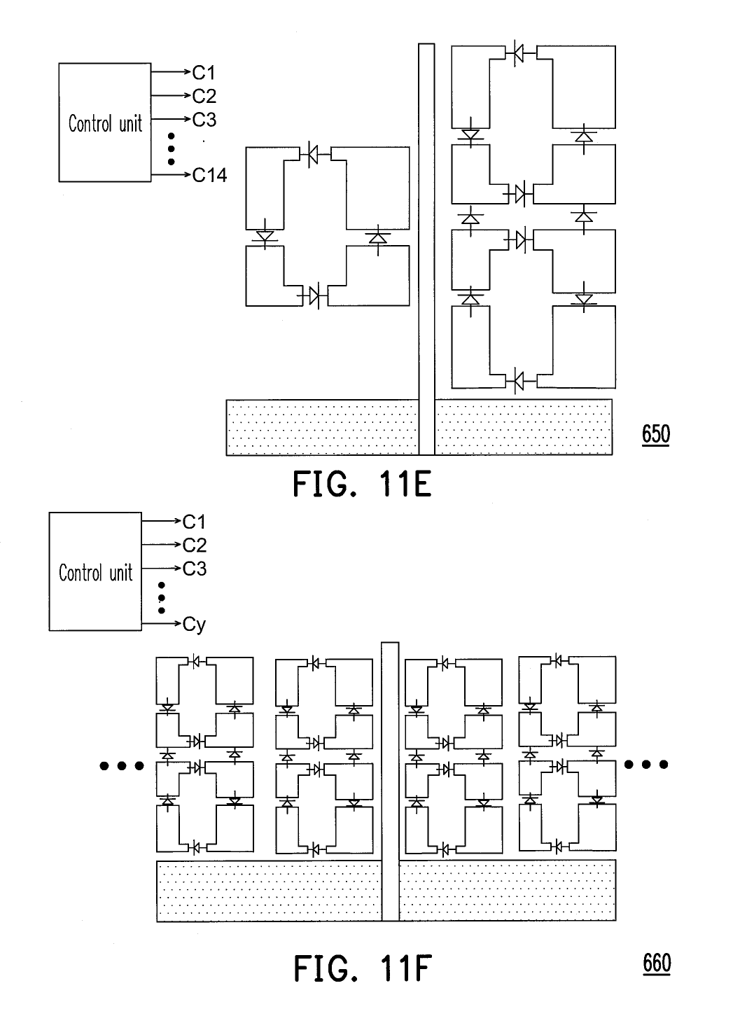

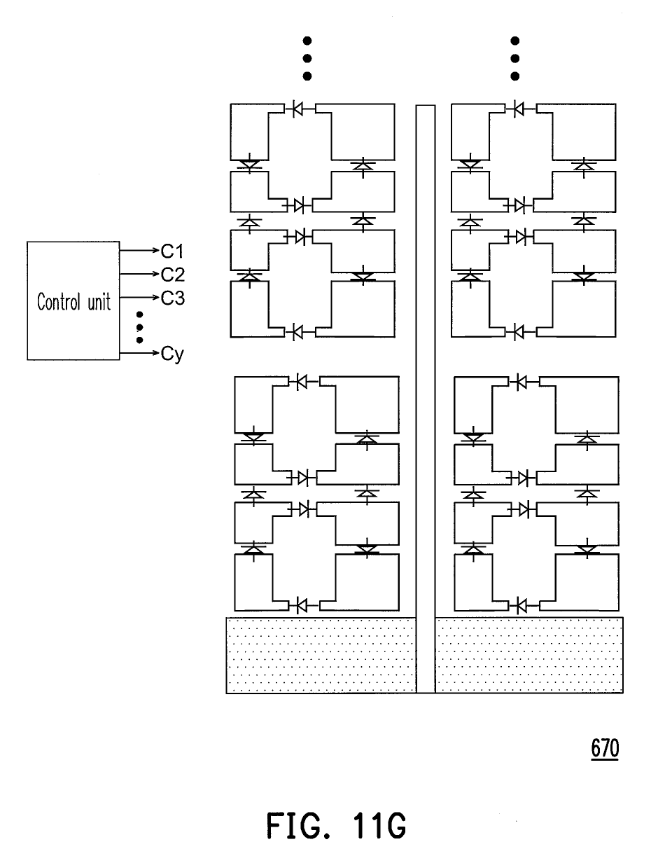

Next, referring to FIG. 11A, FIG. 11A is a plan diagram of the reconfigurable multi-band antenna system 600 provided by an exemplary example. The difference between FIG. 11A and FIG. 1 is that the reconfigurable multi-band antenna system 600 has the switches 611-614 in horizontal direction, the switches 611-614 are respectively connected to the two ends of the semi-close resonators 601-604. In other words, the reconfigurable multi-band antenna system 600 adopts a ring combination structure to connect each of the semi-close resonators 601-604. One end 611-1 of the switch 611 is connected to one end 601-1 of the resonator 601. One end 611-2 of the switch 611 is connected to one end 601-2 of the resonator 601. One end 616-1 of the switch 616 is connected to one end 601-3 of the resonator 601. One end 615-1 of the switch 615 is connected to one end 601-4 of the resonator 601. One end 615-2 of the switch 615 is connected to one end 602-1 of the resonator 602. One end 612-1 of the switch 612 is connected to one end 602-2 of the resonator 602. One end 612-2 of the switch 612 is connected to one end 602-3 of the resonator 602. One end 616-2 of the switch 616 is connected to one end 602-4 of the resonator 602.

One end 617-1 of the switch 617 is connected to one end 603-1 of the resonator 603. One end 613-1 of the switch 613 is connected to one end 603-2 of the resonator 603. One end 613-2 of the switch 613 is connected to one end 603-3 of the resonator 603. One end 618-1 of the switch 618 is connected to one end 603-4 of the resonator 603. One end 618-2 of the switch 618 is connected to one end 604-1 of the resonator 604. One end 614-1 of the switch 614 is connected to one end 604-2 of the resonator 604. One end 614-2 of the switch 614 is connected to one end 604-3 of the resonator 604. One end 617-2 of the switch 617 is connected to one end 604-4 of the resonator 604. When the control unit 610 controls the switches 611-614 to be short, and the switches 615-618 are open, the semi-close resonators 601-604 form four close resonators.

Next, referring to FIG. 11B, FIG. 11B is a plan diagram of the reconfigurable multi-band antenna system 620 provided by an exemplary example. The reconfigurable multi-band antenna system 620 adopts a ring combination structure to connect each of the resonators. Each four non-close resonators 901-904, 905-908, 909-912, or 913-916 of the non-close resonators 901-916 of the reconfigurable multi-band antenna system 620 can be connected to each other to form a close resonator via the switches 921-924, 927-930, 931-934, or 937-940. Furthermore, the non-close resonators 902 and 905 are connected to each other via the switch 925, the non-close resonators 904 and 907 are connected to each other via the switch 926, the non-close resonators 912 and 914 are connected to each other via the switch 935, and the non-close resonators 911 and 913 are connected to each other via the switch 936.

One end 921-1 of the switch 921 is connected to one end 901-1 of the resonator 901. One end 921-2 of the switch 921 is connected to one end 903-2 of the resonator 903. One end 922-1 of the switch 922 is connected to one end 903-1 of the resonator 903. One end 922-2 of the switch 922 is connected to one end 904-2 of the resonator 904. One end 923-1 of the switch 923 is connected to one end 904-1 of the resonator 904. One end 923-2 of the switch 923 is connected to one end 902-2 of the resonator 902. One end 924-1 of the switch 924 is connected to one end 902-1 of the resonator 902. One end 924-2 of the switch 924 is connected to one end 901-2 of the resonator 901. In addition, the connections of each four non-close resonators 905-908, 909-912, and each four switches 927-930, and 931-934 can be deduced by the same manner as mentioned above.

The resonators in FIG. 11B are not the semi-close resonators, and the number of the resonators is different from that of FIG. 11A. Though the resonators in FIG. 11B are not the semi-close resonators, the resonators form close resonators similar to those of FIG. 11A when all of the switches are short. Two ends of each non-close resonator in FIG. 11B are connected to the adjacent two non-close resonators via the switches. Furthermore, except for the two ends of each non-close resonator and adjacent two non-close resonators mentioned above, there is further one end of the each non-close resonator connected to another adjacent one non-close resonator via the switch.

Referring to FIG. 11C and FIG. 11D, FIG. 11C is a plan diagram of the reconfigurable multi-band antenna system 630 provided by an exemplary example, and FIG. 11D is a plan diagram of the reconfigurable multi-band antenna system 640 provided by an exemplary example. The reconfigurable multi-band antenna system 630 and 640 adopt the ring combination structure to connect each of the resonators. Disposing positions of the resonators of the reconfigurable multi-band antenna system 630 are asymmetric in vertical, i.e. forming an asymmetric structure in top and bottom directions; and disposing positions of the resonators of the reconfigurable multi-band antenna system 640 are asymmetric in horizontal, i.e. forming an asymmetric structure in right and left directions.

Referring to FIG. 11E, FIG. 11E is a plan diagram of the reconfigurable multi-band antenna system 650 provided by an exemplary example. The reconfigurable multi-band antenna system 650 adopts the ring combination structure to connect each of the resonators, and the numbers of the resonators on the left and right sides of the reconfigurable multi-band antenna system are different from each other. Referring to FIG. 11F and FIG. 11G, FIG. 11F is a plan diagram of the reconfigurable multi-band antenna system 660 provided by an exemplary example, and FIG. 11G is a plan diagram of the reconfigurable multi-band antenna system 670 provided by an exemplary example. The reconfigurable multi-band antenna system 660 and 670 adopt the ring combination structure to connect each of the resonators. The numbers of the resonators on the left and right sides of the reconfigurable multi-band antenna system 660 have no limitation, and the arrangement of the resonators on the left and right sides can extend forward the right and left direction arbitrarily. In addition, the numbers of the resonators on the left and right sides of the reconfigurable multi-band antenna system 670 have no limitation, and the arrangement of the resonators on the left and right sides can extend forward the top and bottom direction arbitrarily.

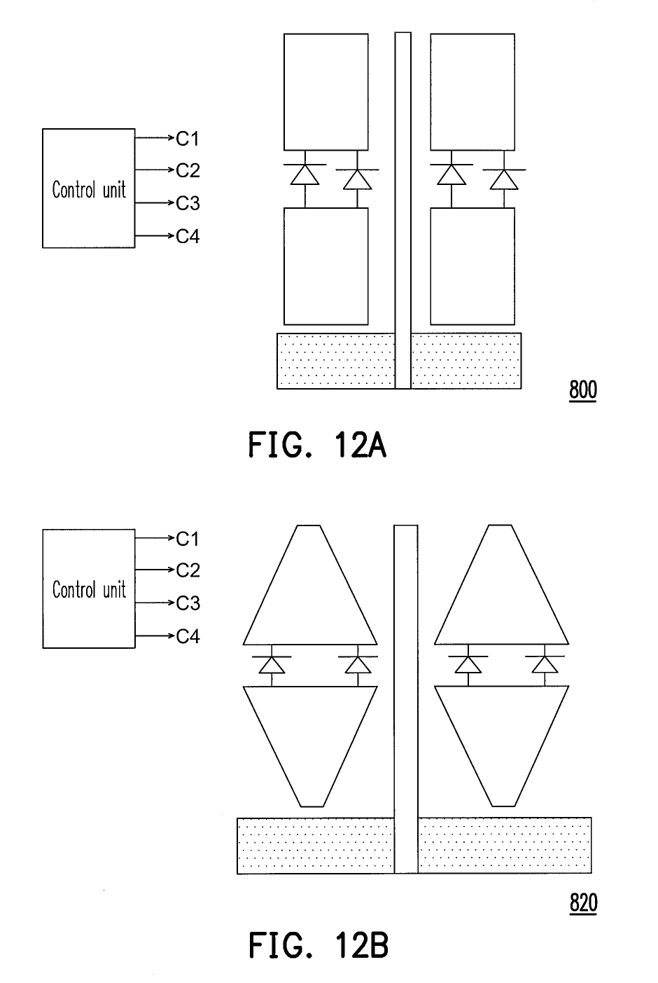

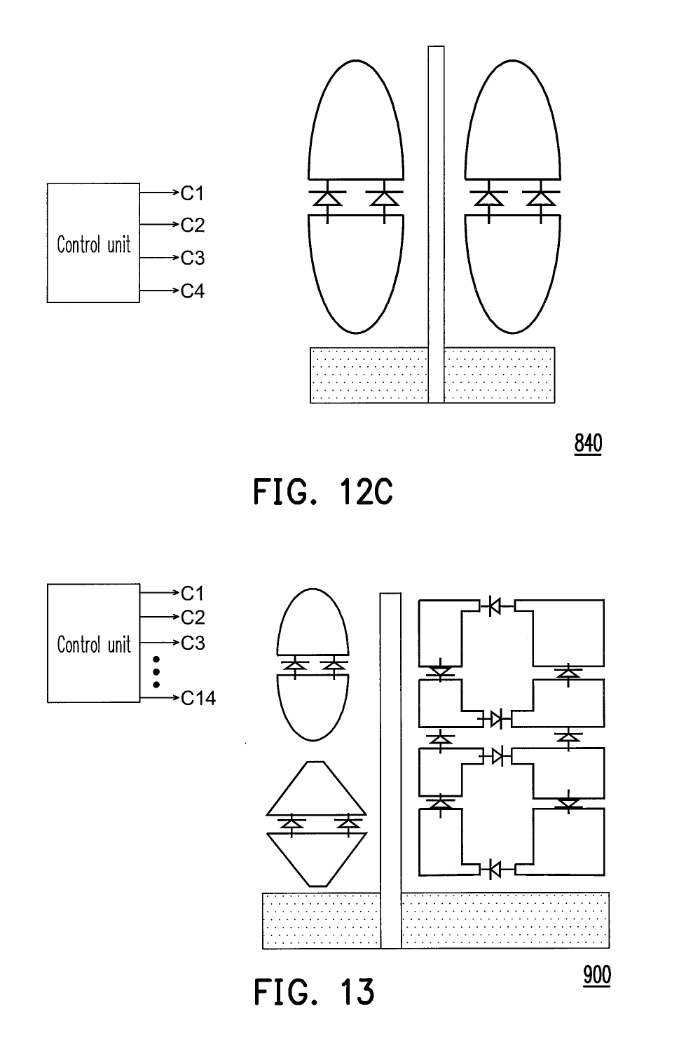

Next, referring to FIG. 12A-12C, FIG. 12A is a plan diagram of reconfigurable multi-band antenna system 800 provided by an exemplary example. FIG. 12B is a plan diagram of the reconfigurable multi-band antenna system 820 provided by an exemplary example. FIG. 12C is a plan diagram of the reconfigurable multi-band antenna system 840 provided by an exemplary example. The resonators of the reconfigurable multi-band antenna system 800 are resonators of the square or rectangle shape, and the resonators of the reconfigurable multi-band antenna system 820 are resonators of the quadrangle shapes (e.g. resonators of the trapezoid shapes). In addition, the resonators of the reconfigurable multi-band antenna system 840 are resonators of the semi-circle or semi-ellipse shapes. Except for the shapes illustrated in FIG. 12A-12C, the shapes of the resonator can further be polygons, such as isosceles triangles, regular pentagons, or regular dodecagons.

Next, referring to FIG. 13, FIG. 13 is a plan diagram of the reconfigurable multi-band antenna system 900 provided by an exemplary example. The reconfigurable multi-band antenna system 900 adopts the different structure types of the resonators on the right and left sides, wherein the resonators on left side are the resonators of the quadrangle and semi-ellipse shapes, and the resonators on right side are the resonators of the ring combination structure. It is noted that, in the other exemplary example (not shown in the drawings), the resonators on left side are the resonators of the ring combination structure, and the resonators on right side are the resonators of the quadrangle and semi-ellipse shapes.

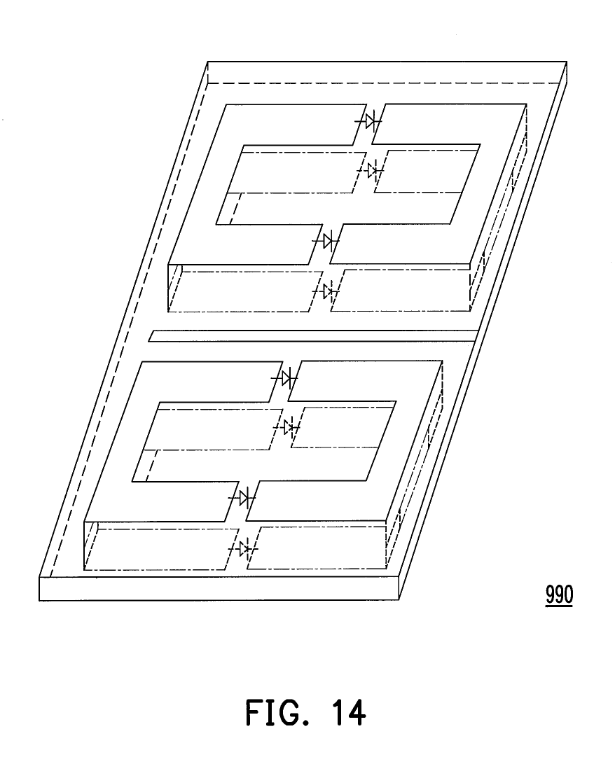

Last, referring to FIG. 14, FIG. 14 is a perspective diagram of the reconfigurable multi-band antenna system 990 provided by an exemplary example. The structures of the the reconfigurable multi-band antenna systems mentioned above are two dimensional structures. However, to increase the resonating modes and decrease area, the reconfigurable multi-band antenna system 990 in FIG. 14 adopts a simple three dimensional structure. As shown in FIG. 14, except for the resonators on the top and bottom sides, the same resonators are added in the rear side of the substrate, and the resonators on the top and bottom sides are connected to each other, so as to implement the three dimensional reconfigurable multi-band antenna system.

According to the reconfigurable multi-band antenna system mentioned above, it is known that the shape, connection, number, disposing position are not limited thereto. In addition, the reconfigurable multi-band antenna system can be applied on the electronic apparatuses, and the reconfigurable multi-band antenna system is electrically connected to the transceiving chip of the reconfigurable multi-band antenna system.

To sum up, the reconfigurable multi-band antenna system mentioned above can control the switches to be short (i.e. turned on) or open (i.e. turned off) via the controls signals, such that the resonator configurations finally formed by the resonators are different from each other, and therefore the reconfigurable multi-band antenna system is able to operate in different frequency bands. Area of the reconfigurable multi-band antenna system is reduced, and the reconfigurable multi-band antenna system a system is able to receive the signals within different frequencies by using a structure of the single antenna.

It will be apparent to those skilled in the art that various modifications and variations can be made to the structure of the disclosure without departing from the scope or spirit of the disclosure. In view of the foregoing descriptions, it is intended that the present disclosure covers modifications and variations of this disclosure if they fall within the scope of the following claims and their equivalents.

What is claimed is:

1. A reconfigurable multi-band antenna system, comprising:
a signal transmission metal, for acting as a signal feed-in end of the reconfigurable multi-band antenna system;
a ground metal, for acting as a ground end of the reconfigurable multi-band antenna system;
at least two resonators, arranged on at least one side of the signal transmission metal; and
at least two switches, each of the switches is coupled to the at least two resonators or one of the resonators, and has a control end, and each of the switches respectively and independently receives one of at least two control signals;
wherein the at least two control signals respectively and independently control the switches to be open or short, and the at least two resonators thus form a resonator configuration of a semi-close or close resonating configuration, and generates a signal within a frequency according to the resonator configuration.

2. The reconfigurable multi-band antenna system as claimed in claim 1, wherein the reconfigurable multi-band antenna system comprises four resonators and four switches, and each of the switches has the control end for respectively and independently receiving one of four control signals, the four resonators comprises a first semi-close resonator, a second semi-close resonator, a third semi-close resonator, and a fourth semi-close resonator, the first semi-close resonator has a first end and a second end, the second semi-close resonator has a third end and a fourth end, the third semi-close resonator has a fifth end and a sixth end, the fourth semi-close resonator has a seventh end and an eighth end, the four switches comprises a first switch, a second switch, a third switch, and a fourth switch, the four control signals comprises a first control signal, a second control signal, a third control signal, and a fourth control signal, wherein the first and second semi-close resonators are arranged on one side of the signal transmission metal, and the third and fourth semi-close resonators are arranged on the other one side of the signal transmission metal opposing to the side of the signal transmission metal, the first switch is connected between the first and third ends, the second switch is connected between the second and fourth ends, the third switch is connected between the fifth and seventh ends, the fourth switch is connected between the sixth and eighth ends, when the first, second, third, and fourth control signals respectively control the first, second, third, and fourth switches to be short, the first and second semi-close resonators, and the third and fourth semi-close resonators form a combination of two close resonators.

3. The reconfigurable multi-band antenna system as claimed in claim 1, wherein the reconfigurable multi-band antenna system comprises three resonators and three switches, and each of the switches has the control end for respectively and independently receiving one of three control signals, the three resonators comprise a first semi-close resonator, a second semi-close resonator, and a third semi-close resonator, the first semi-close resonator has a first end and a second end, the second semi-close resonator has a third end and a fourth end, the third semi-close resonator has a fifth end and a sixth end, the three switches comprise a first switch, a second switch, and a third switch, the three control signals comprise a first control signal, a second control signal, and a third control signal, wherein the first and second semi-close resonators are arranged on one side of the signal transmission metal, and the third semi-close resonator is arranged on the other one side of the signal transmission metal opposing to the side of the signal transmission metal, the first switch is connected between the first and third ends, the second switch is connected between the second and fourth ends, the third switch is connected between the fifth and sixth ends, when the first, second, and third control signals respectively control the first, second, and third switches to be short, the first and second semi-close resonators, and the third semi-close resonator form a combination of two close resonators.

4. The reconfigurable multi-band antenna system as claimed in claim 1, wherein the reconfigurable multi-band antenna system comprises three resonators and two switches, and each of the switches has the control end for respectively and independently receiving one of two control signals, the three resonators comprise a first semi-close resonator, a second semi-close resonator, and a first close resonator, the first semi-close resonator has a first end and a second end, the second semi-close resonator has a third end and a fourth end, the two switches comprise a first switch and a second switch, the two control signals comprise a first control signal and a second control signal, wherein the first and second semi-close resonators are arranged on one side of the signal transmission metal, and the first close resonator is arranged on the other one side of the signal transmission metal opposing to the side of the signal transmission metal, the first switch is connected between the first and third ends, the second switch is connected between the second and fourth ends, when the first, second, and third control signals respectively control the first and second switches to be short, the first and second semi-close resonators, and the first close resonator form a combination of two close resonators.

5. The reconfigurable multi-band antenna system as claimed in claim 2, wherein the four resonators are resonators having non-uniform line widths, and the four resonators are asymmetrically arranged on the two sides of the signal transmission metal.

6. The reconfigurable multi-band antenna system as claimed in claim 2, wherein the four resonators are resonators having non-uniform line widths, and the four resonators are symmetrically arranged on the two sides of the signal transmission metal.

7. The reconfigurable multi-band antenna system as claimed in claim 2, further comprising four inner resonators and four inner switches, and each of the inner switches has the control end for respectively and independently receiving one of four inner control signals, the four inner resonators comprise a first semi-close inner resonator, a second semi-close inner resonator, a third semi-close inner resonator, and a fourth semi-close inner resonator, the first semi-close inner resonator has a ninth end and a tenth end, the second semi-close inner resonator has an eleventh end and a twelfth end, the third semi-close inner resonator has a thirteenth end and a fourteenth end, the fourth semi-close inner resonator has a fifteenth end and an sixteenth end, the four inner switches comprise a first inner switch, a second inner switch, a third inner switch, and a fourth inner switch, the four inner control signals comprise a first inner control signal, a second inner control signal, a third inner control signal, and a fourth inner control signal, wherein the first and second semi-close inner resonators are arranged on one side of the signal transmission metal, and arranged on inner sides of the first and second semi-close resonators, and the third and fourth semi-close inner resonators are arranged on the other one side of the signal transmission metal opposing to the side of the signal transmission metal, and arranged on inner sides of the third and fourth semi-close resonators, the first inner switch is connected between the ninth and eleventh ends, the second inner switch is connected between the tenth and twelfth ends, the third inner switch is connected between the thirteenth and fifteenth ends, the fourth inner switch is connected between the fourteenth and sixteenth ends, when the first, second, third, and fourth inner control signals respectively control the first, second, third, and fourth inner switches to be short, and when the first, second, third, and fourth control signals respectively control the first, second, third, and fourth switches to be short, the first and second semi-close resonators, and the third and fourth semi-close resonators form a combination of two close resonators, and the first and second semi-close inner resonators, and the third and fourth semi-close inner resonators form a combination of two close inner resonators.

8. The reconfigurable multi-band antenna system as claimed in claim 2, further comprising four inner resonators and four inner switches, and each of the inner switches has the control end for respectively and independently receiving one of four inner control signals, the four inner resonators comprise a first semi-close inner resonator, a second semi-close inner resonator, a third semi-close inner resonator, and a fourth semi-close inner resonator, the first semi-close inner resonator has a ninth end and a tenth end, the second semi-close inner resonator has an eleventh end and a twelfth end, the third semi-close inner resonator has a thirteenth end and a fourteenth end, the fourth semi-close inner resonator has a fifteenth end and an sixteenth end, the four inner switches comprise a first inner switch, a second inner switch, a third inner switch, and a fourth inner switch, the four inner control signals comprise a first inner control signal, a second inner control signal, a third inner control signal, and a fourth inner control signal, wherein the first and second semi-close inner resonators are arranged on one side of the signal transmission metal, and arranged on inner sides of the first and second semi-close resonators, and the third and fourth semi-close inner resonators are arranged on the other one side of the signal transmission metal opposing to the side of the signal transmission metal, and arranged on inner sides of the third and fourth semi-close resonators, the first inner switch is connected between the ninth and eleventh ends, the second inner switch is connected between the tenth and twelfth ends, the third inner switch is connected between the thirteenth and fifteenth ends, the fourth inner switch is connected between the fourteenth and sixteenth ends, when the first, second, third, and fourth inner control signals respectively control the first, second, third, and fourth inner switches to be short, and when the first, second, third, and fourth control signals respectively control the first, second, third, and fourth switches to be short, the first and second semi-close resonators, and the third and fourth semi-close resonators form a combination of two close resonators, and the first and second semi-close inner resonators, and the third and fourth semi-close inner resonators form a combination of two semi-close inner resonators.

9. The reconfigurable multi-band antenna system as claimed in claim 2, further comprising four inner resonators and four inner switches, and each of the inner switches has the control end for respectively and independently receiving one of four inner control signals, the four inner resonators comprise a first close inner resonator, a second close inner resonator, a third close inner resonator, and a fourth close inner resonator, the first close inner resonator has a ninth end and a tenth end, the second close inner resonator has an eleventh end and a twelfth end, the third close inner resonator has a thirteenth end and a fourteenth end, the fourth close inner resonator has a fifteenth end and an sixteenth end, the four inner switches comprise a first inner switch, a second inner switch, a third inner switch, and a fourth inner switch, the four inner control signals comprise a first inner control signal, a second inner control signal, a third inner control signal, and a fourth inner control signal, wherein the first and second close inner resonators are arranged on one side of the signal transmission metal, and arranged on inner sides of the first and second semi-close resonators, and the third and fourth close inner resonators are arranged on the other one side of the signal transmission metal opposing to the side of the signal transmission metal, and arranged on inner sides of the third and fourth semi-close resonators, the first inner switch is connected between the ninth and eleventh ends, the second inner switch is connected between the tenth and twelfth ends, the third inner switch is connected between the thirteenth and fifteenth ends, the fourth inner switch is connected between the fourteenth and sixteenth ends, when the first, second, third, and fourth inner control signals respectively control the first, second, third, and fourth inner switches to be short, and when the first, second, third, and fourth control signals respectively control the first, second, third, and fourth switches to be short, the first and second semi-close resonators, and the third and fourth semi-close resonators form a combination of two close resonators, and the first and second close inner resonators, and the third and fourth close inner resonators form a combination of two close inner resonators.

10. The reconfigurable multi-band antenna system as claimed in claim 2, further comprising a fifth switch, a sixth switch, a seventh switch, and an eighth switch, the first semi-close resonator further comprises a ninth end and a tenth end, the second semi-close resonator further comprises an eleventh end and a twelfth end, the third semi-close resonator further comprises a thirteenth end and a fourteenth end, the fourth semi-close resonator further comprises a fifteenth end and a sixteenth end, the fifth, sixth, seventh, and eighth switches respectively control ends for receiving a fifth control signal, a sixth control signal, a seventh control signal, and an eighth control signal, the two ends of the fifth switch are connected to the ninth and tenth ends, the sixth switch are connected to the eleventh and twelfth ends, the seventh switch are connected to the thirteenth and fourteenth ends, the eighth switch are connected to the fifteenth and sixteenth ends.

11. The reconfigurable multi-band antenna system as claimed in claim 1, wherein the reconfigurable multi-band antenna system comprises four resonators and four switches, and each of the switches has the control end for respectively and independently receiving one of four control signals, the four resonators comprise a first non-close resonator, a second non-close resonator, a third non-close resonator, and a fourth non close resonator, the first non-close resonator has a first end and a second end, the second non-close resonator has a third end and a fourth end, the third non-close resonator has a fifth end and a sixth end, the fourth non-close resonator has a seventh end and an eighth end, the four switches comprise a first switch, a second switch, a third switch, and a fourth switch, the four control signals comprise a first control signal, a second control signal, a third control signal, and a fourth control signal, wherein the first, second, third, and fourth non-close resonators are arranged on one side of the signal transmission metal, the first switch is connected between the first and eighth ends, the second switch is connected between the second and third ends, the third switch is connected between the fourth and fifth ends, the fourth switch is connected between the sixth and seventh ends, when the first, second, third, and fourth control signals respectively control the first, second, third, and fourth switches to be short, the first, second, third, and fourth semi-close resonators form a combination of at least one close resonator.

12. The reconfigurable multi-band antenna system as claimed in claim 1, wherein each of the at least resonators is a resonator of a square shape, a resonator with of a quadrilateral shape, a resonator with of a cycle shape, a resonator with of a polygon shape, or a resonator with of an ellipse shape.

13. The reconfigurable multi-band antenna system as claimed in claim 11, further comprising a first semi-close resonator, a second semi-close resonator, a fifth switch, and a sixth switch, the first and second semi-close resonators are arranged on the other one side of the signal transmission metal opposing to the side of the signal transmission metal, each of the fifth and sixth switch has a control end for receiving one of a fifth and sixth control signals, the first semi-close resonator has a ninth end and a tenth end, the second semi-close resonator has a eleventh end and a twelfth end, the fifth switch is connected between the ninth and eleventh ends, the sixth switch is connected between the tenth and twelfth ends, when the first, second, third, fourth, fifth, and sixth control signals respectively control the first, second, third, fourth, fifth, and sixth switches to be short, the first and second non-close resonators, the third and fourth non-close resonators, and the first and second semi-close resonators form a combination of two close resonators.

14. The reconfigurable multi-band antenna system as claimed in claim 1, wherein each of the at least two switches is a P-doped Instinct N-Doped (PIN) diode switch, a Radio Frequency MicroElectroMechanical System (RF MEMS) switch, or a Metal-Oxide-Semiconductors (MOS) switch.

15. The reconfigurable multi-band antenna system as claimed in claim 1, further comprising a control unit for generating the at least two control signals.

16. The reconfigurable multi-band antenna system as claimed in claim 15, wherein the at least two control signals are generated according to an environmental condition of a channel or a communication standard.

17. The reconfigurable multi-band antenna system as claimed in claim 1, further comprising a substrate.

18. An electronic apparatus, comprising:
a transceiving chip; and
a reconfigurable multi-band antenna system, electrically connected to the transceiving chip, comprising:
a signal transmission metal, for acting as a signal feed-in end of the reconfigurable multi-band antenna system;
a ground metal, for acting as a ground end of the reconfigurable multi-band antenna system;
at least two resonators, arranged on at least one side of the signal transmission metal; and
at least two switches, each of the switches is coupled to the at least two resonators or one of the resonators, and has a control end, and each of the switches respectively and independently receives one of at least two control signals;
wherein the at least two control signals respectively and independently control the switches to be open or short, and the at least two resonators thus form a resonator configuration of a semi-close or close resonating configuration, and generates a signal within a frequency according to the resonator configuration.
